(19) United States
(12) Patent Application Publication
(10) Pub. No.: US 2010/0181699 A1
(43) Pub. Date: Jul. 22, 2010

(54) CONCRETE SLEEPER AND METHOD FOR PRODUCING THE SAME

(75) Inventors: Stephan Freudenstein, Neumarkt (DE); Viktor Klein, Pilsach (DE); Franz Geissler, Velburg (DE)

Correspondence Address: LUCAS & MERCANTI, LLP, 475 PARK AVENUE SOUTH, 15TH FLOOR, NEW YORK, NY, 10016, US

(73) Assignee: RAIL.ONE GMBH, Neumarkt (DE)

(21) Appl. No.: 12/527,955

(22) PCT Filed: Jan. 3, 2008
(86) PCT No.: PCT/DE08/00002

§ 371 Date: Mar. 17, 2010

(30) Foreign Application Priority Data
Feb. 20, 2007 (DE) 10 2007 008 704.9

(51) Int. Cl. B28B 5/08

(52) U.S. Cl. 264/228

(57) ABSTRACT

Method of manufacturing a concrete sleeper, comprising the following steps: insertion of pre-stressing rods into a sleeper mould, simultaneous automated tensioning of the individual pre-stressing rods, filling of the sleeper mould with concrete, leaving of the concrete to harden, removal of the concrete sleeper from the mould, wherein for one concrete sleeper more than four, in particular five to eight, pre-stressing rods are used and the pre-stressing rods are tensioned individually yet simultaneously.

The invention relates to a method of manufacturing a concrete sleeper comprising the following steps: insertion of pre-stressing rods into a sleeper mould, tensioning of the pre-stressing rods, filling of the sleeper mould with concrete, leaving the concrete to harden and removal of the concrete sleeper from the mould.

For the manufacture of pre-stressed concrete sleepers, sleeper moulds are used which are continuously in rotation. After cleaning of the sleeper moulds, they are filled with liquid concrete, then they pass through a shaking station. The hardening time of the liquid concrete poured into the sleeper moulds can be shortened by applying heat, e.g. in a heat chamber. If the concrete has sufficient hardness, the sleeper moulds are lifted and turned over so that the concrete sleepers can be removed from the mould.

Conventional concrete sleepers usually have four embedded pre-stressing rods, which are disposed in two rows, spaced apart laterally. Sleepers with a reinforcement of this type are however only suitable subject to certain conditions, if at all, for high axial loads.

These conventional pre-stressed concrete sleepers are manufactured in the rotation method. In this, all four pre-stressing rods are tensioned simultaneously and automatically, but individually and are de-tensioned in exactly the same way.

Sleepers are also known having eight pre-stressing rods, which are tensioned simultaneously and automatically and de-tensioned again, and in the conventional method with more than four pre-stressing wires, these are then gathered into bundles composed of at least two pre-stressing rods each and then these bundles are tensioned together.

Also known is the manufacturing method in the “long pre-stressing bed”, in which virtually any number of pre-stressing rods can be inserted into the pre-stressing bed.

In this case, conventionally 12 to 24 pre-stressing wires are used, which are tensioned one after another and held at the end with wedges. In this method, however, the cost of the long moulds necessary is very high.

The object of the invention is to indicate a simple, economical method of manufacturing a concrete sleeper which is suitable for high axial loads.

To achieve this object, in a method of the type mentioned in the introduction, it is proposed according to the invention that for one concrete sleeper more than four, in particular five to eight, pre-stressing rods are used, which are tensioned individually but simultaneously and are de-tensioned again in just the same way. This tensioning operation is effected by means of a corresponding tensioning device in an automated manner, and the de-tensioning operation takes place in just the same way. The axial load to be absorbed by the reinforced concrete sleeper is absorbed according to the invention by more than four, in particular five to eight, pre-stressing rods. The pre-stressing rods can in this case sometimes be thinner than conventional pre-stressing rods, producing improved load distribution. In the conventional method, a maximum of four pre-stressing rods has been used, since in the rotation method the conventional tensioning devices did not permit the simultaneous, automatic tensioning of a larger number of pre-stressing rods, and furthermore where there are more than four pre-stressing rods, space problems arise, which complicate automatic tensioning.

In the method according to the invention, it is preferred that both ends of a pre-stressing rod have a thread and one end is anchored in a tie bolt spindle and the other end is tensioned with a tensioning spindle and fixed with spindle nuts which bear on the sleeper mould. In order to tension, a pull is exerted on the tensioning spindles and then the nuts are screwed on to the thread, retaining the necessary bias in the pre-stressing rod.

It is particularly preferred that pre-stressing rods are used having a ribbed or profiled surface. With such a surface, a firm adhesion is created between the pre-stressing rod and the surrounding concrete and hence good transmission of force.

Within the scope of the invention, it can be provided that plural, preferably two to eight, adjacent concrete sleepers are manufactured in one sleeper mould. Thus a larger number of concrete sleepers can be manufactured simultaneously. Further method features are described in the subclaims.

In addition, the invention relates to a concrete sleeper with a reinforcement composed of pre-stressed rods and optionally slack reinforcement.

The concrete sleeper according to the invention is characterised in that it is manufactured according to the method described and has more than four, in particular five to eight, pre-stressing rods.

Further advantages and details of the invention will be described with the aid of examples with reference to the drawings, which are schematic diagrams showing:

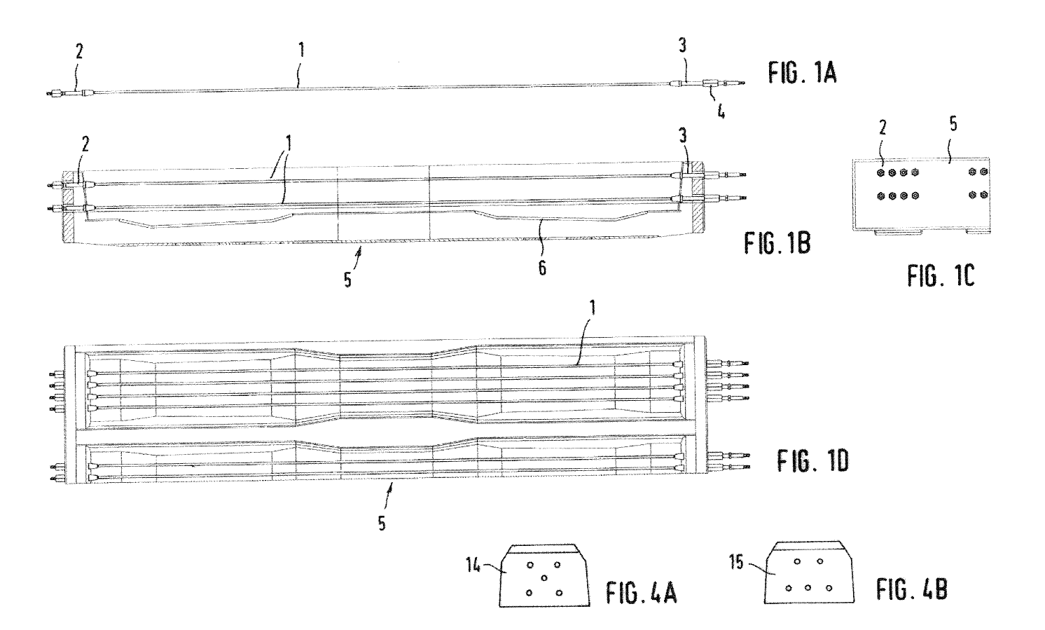

FIG. 1A a pre-stressing rod which is used in the method according to the invention;

FIG. 1B a sleeper mould in a side view shown in section with pre-stressing rods inserted;

FIG. 1C a detail of a front view of the sleeper mould from FIG. 1B;

FIG. 1D a detail of a plan view of the sleeper mould from FIG. 1B;

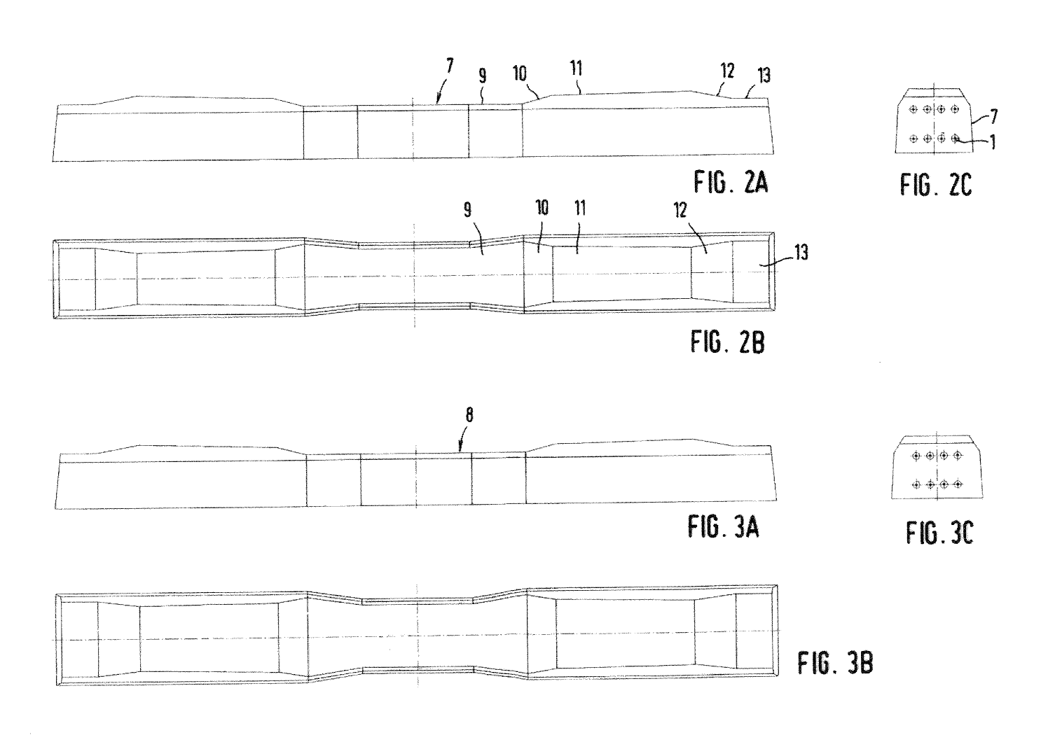

FIG. 2A a side view of a concrete sleeper according to the invention;

FIG. 2B a plan view of the concrete sleeper from FIG. 2A;

FIG. 2C a front view of the concrete sleeper from FIG. 2A;

FIG. 3A a further embodiment of a concrete sleeper according to the to 3C invention; and

FIG. 4A further embodiments of concrete sleepers according to the and 4B invention.

FIG. 1A shows a pre-stressing rod 1 which has at one end a tie bolt 2 in order to fix the pre-stressing rod 1 in a sleeper mould. At the other end of the pre-stressing rod 1 is a tensioning bolt 3, which has a thread, on to which a nut 4 is screwed.

FIG. 1B shows a sleeper mould 5 in a side view partially in section. In the sleeper mould 5, plural pre-stressing rods 1 are fixed via tie bolts 2 and tensioning bolts 3. The inner contour 6 of the sleeper mould 5 is adapted to the shape of the concrete sleeper to be manufactured. For different concrete sleepers, different sleeper moulds are used or the sleeper moulds can be varied by mould inlays or plate inserts. As can be best seen from FIG. 1D, in the sleeper mould 5 plural adjacently disposed concrete sleepers can be manufactured in one operation. The tie bolts 2 and the tensioning bolts 3 respectively bear on the end faces of the sleeper mould 5. The tensioning of the pre-stressing rods 1 is effected by simultaneous pulling of the tensioning spindles, which are simultaneously fixed by rotation of the nuts 4. In the embodiment shown, each concrete sleeper has eight pre-stressing rods, which are disposed in two opposing rows of four pre-stressing rods 1 each.

In the manufacture of the concrete sleepers, first the pre-stressing rods 1 are inserted into the sleeper mould 5. Then the pre-stressing rods 1 are tensioned simultaneously, each pre-stressing rod 1 being tensioned individually. Then the liquid concrete is poured into the sleeper mould 5 and compressed by shaking. Hardening takes place of its own accord, but can be accelerated by heat application. The finished concrete sleepers can then be removed from the mould.

FIGS. 2A to 2C, 3A to 3C and 4A and 4B show respective embodiments of concrete sleepers which have been manufactured according to the method described. The concrete sleepers 7, 8 are symmetrically constructed. The central, plane section 9 on the upper face of the concrete sleeper 7 is joined laterally by an oblique section 10, which is bordered by a slightly inclined section 11, whose incline is roughly 1:40 in the embodiment shown. An oblique section 12 adjoins this, and the end region 13 of the concrete sleeper 7 is plane. The concrete sleeper has eight pre-stressing rods 1. As can best be seen from FIG. 2B, the concrete sleeper 7 is narrowed laterally in its central section. The rail support of the concrete sleeper 7 has a lower width of approximately 320 to 380 mm.

The concrete sleeper 8 shown in FIGS. 3A to 3C has substantially the same construction as the concrete sleeper shown in FIGS. 2A to 2C. Since both concrete sleepers 7, 8 each have eight embedded pre-stressing rods, they are capable of absorbing high axial loads.

A further embodiment of a concrete sleeper which has been manufactured according to the method described is shown in FIG. 4A in a section view. The concrete sleeper 14 has five pre-stressing rods, four of which are arranged as the corner points of a square and a fifth pre-stressing rod is disposed in the centre. A further embodiment of a concrete sleeper is shown in FIG. 4B in a section view. The concrete sleeper 15 likewise has five pre-stressing rods, three of which are disposed in the lower row and two in the upper row, the pre-stressing rods of the lower and upper rows being staggered with respect to one another.

1-16. (canceled)

17. Method of manufacturing a concrete sleeper in the rotation method, comprising the following steps:
inserting four or more pre-stressing rods into a sleeper mould;
individually and simultaneously tensioning the individual pre-stressing rods such that the pre-stressing rods are tensioned individually and simultaneously;
filling of the sleeper mould with concrete;
leaving the concrete to harden; and
removing the concrete sleeper from the mould.

18. The method of claim 17, wherein both ends of a pre-stressing rod have a thread and one end is anchored in a tie bolt spindle and the other end is tensioned with a tensioning spindle and is fixed by means of spindle nuts which bear on the sleeper mould.

19. The method of claim 17, wherein the pre-stressing rods have a ribbed surface.

20. The method of claim 17, wherein the pre-stressing rods have a profiled surface.

21. The method of claim 17, wherein the pre-stressing rods have a smooth surface and end anchoring.

22. The method of claim 17, wherein a plurality of adjacently disposed concrete sleepers are manufactured in one sleeper mould.

23. The method of claim 17, wherein eight pre-stressing rods, two rows disposed one over another and each having four pre-stressing rods are inserted into the mould.

24. The method of claim 17, wherein five pre-stressing rods, the pre-stressing rods arranged as the corner points of a square with a center point or asymmetrically, are inserted into the mould.

25. The method of claim 17, wherein the pre-stressing rods are de-tensioned individually and simultaneously before removal of the concrete sleeper from the mould.
